(19) United States
(12) Patent Application Publication
(10) Pub. No.: US 2015/0199669 A1
(43) Pub. Date: Jul. 16, 2015

(54) METHOD AND SYSTEM FOR MANAGING AND MONETIZING EXCLUSIVE CONTENT IN SOCIAL NETWORKING SPACE

(71) Applicants: Nicolas Michael Ramirez, Sherman Oaks, CA (US); Seth Michael Howard, Sherman Oaks, CA (US)

(72) Inventors: Nicolas Michael Ramirez, Sherman Oaks, CA (US); Seth Michael Howard, Sherman Oaks, CA (US)

(73) Assignee: TRIPLE SEVEN MEDIA, SHERMAN OAKS, CA (US)

(21) Appl. No.: 14/154,514

(22) Filed: Jan. 14, 2014

(51) Int. Cl. G06Q 20/22; H04L 29/08; G06Q 50/00

(52) U.S. Cl. CPC G06Q 20/22; G06Q 50/01; H04L 67/22

(57) ABSTRACT

The present invention provides methods and systems for monetizing content of a first user of a social networking platform. The methods and systems include receiving a request from a second user in a social networking connections of the first user, accepting the second user in the social networking connections of the first user based on the enrollment in at least one of the subscription model by a third party, delivering a subset of content of the first user to the second user for a pre-defined period of time through a pre-defined communication channel, and disassociating the second user from the social networking connections after the expiry of at least one of the subscription model. The second user sends the request by enrolling for at least one of a subscription model. The third party is authorized by the first user and the content is posted by the first user.

### FIELD OF THE INVENTION

The present invention relates to social networking space, and more particularly, relates to methods and systems for managing and monetizing exclusive content in the social networking space.

### BACKGROUND OF THE INVENTION

Social networking platforms have become deeply embedded into the social fabric of modern day life. Examples of these platforms include but may not be limited to Facebook, Google+, FourSquare, LinkedIn, and Twitter. These platforms support a variety of functions, ranging from sharing daily activities and photos to use as corporate advertising and marketing channels. In addition, these platforms allow users to associate themselves with other users, thereby creating a web of connections among the users of a social networking platform. Further, these platforms enable connecting members to content that is most likely to be relevant to each member. For example, members may be grouped according to one or more common attributes in their profiles, such as geographic location, employer, job type, age, music preferences, interests, or other attributes.

In addition, these platforms are used by celebrities who create their own page. The celebrity can be a music artist, a sportsperson, a politician, a dancer, a media personality, an actor, a corporate executive, an athlete, a group including one or more of all these people, a music band, a team, and the like. These platforms enable individuals to search for these celebrities, connect to them by liking their respective web pages and follow them. These celebrities post their pictures/videos/any other content related to their personal and/or professional life. These pictures/ pictures/videos/any other content related to their personal and/or professional life posted by these celebrities can be accessed only by their fans that have already “liked” or “followed” them. For example, a celebrity X may be followed by one million fans on a social networking platform. The celebrity X may post his recent family function photos/videos on this platform and allows access to view these photos/videos by his/her fans. Owing to a small time span of stardom in which a celebrity generally enjoys a huge fan following, the celebrity may want to monetize his/her stardom. In the prior art, there have been some systems, in which the celebrity can monetize the huge fan following.

Advertising celebrity-related products to fans is a well known practice, utilizing various media such as television and the internet. However, only a handful of methods exist for effectively targeting narrow audiences such as fans of a specific celebrity, sports team or television show. These methods include placing ads (advertisements) in specific websites, content targeted ads and carefully placed commercials. However, advertisers are always looking for new methods and media to increase the exposure of their offerings.

In addition to the advertising of celebrity-related products, another related field is celebrity-assisted advertising (not necessarily of celebrity-related products). Celebrities have been participating in advertising campaigns for many years, and advertisers find this to be very effective in setting trends towards their products and raising the exposure of these products. This affinity of advertisers towards celebrities has in recent years spawned another phenomenon—advertisers have been handing out various products to celebrities, free of charge, at almost every opportunity, in the hope of having the celebrities seen with the products or mentioning them in public, enabling the advertiser to then refer to the product “as used by such and such”. Even the very publicity of the give-away is sometimes enough to earn positive press coverage and prestige for the giver, therefore advertisers often compete amongst themselves in the value and magnitude of such gifts.

The Internet is being slowly expanded to provide services to celebrities and sometimes to their fans. Korean Patent Application Number KR2084843 titled “Method for supplying cultural commodity utilizing global star network infra” related to a method for supplying a cultural commodity utilizing a global star (i.e. celebrity) network infrastructure, provided to plan a communication among stars and a construction of a community by supplying a space for only stars, on-line or off-line, and to plan an activation of a star industry by providing a space for sharing information among stars and/or a star and fan. This application focuses on inter-star interaction and social networking and not on interaction with fans.

Korean Patent Application Number KR3030809A titled “Online fan letter service system” relates to an online fan letter service system that is provided to notify a user whether a celebrity opens and reads his/her fan letters thereby enhancing the reliability of the fan letters. The system comprises a fan terminal, a celebrity terminal, a fan letter service server, a database, an SMS (Short Message Service) system, a CD production system, and the internet. The fan terminal and the celebrity terminal enable a fan and a celebrity to access the fan letter service server over the internet, respectively. The server transmits the fan letter from the fan terminal to the celebrity terminal, informs the fan terminal whether the celebrity opens and reads the fan letter, manages the database and sends instructions to the SMS system and the CD production system if necessary. The SMS system receives the instructions from the server, and sends the short message, made at the celebrity terminal, to the fan terminal over a wireless communication network. The CD production system records the fan letter on a CD according to the instruction from the server, and delivers the produced CD to the celebrity or the fan. This system provides the fan with an indication that the celebrity has accessed the fan mail, but it is still essentially a one-way interaction. The celebrity does not gain from the interaction and the fan does not get personalized response.

Japanese Patent Application Number JP2002328994 titled “System to Mediate Between Celebrities And Their Fans And Computer Program” relates to a communication agency system having a program server containing information about celebrities received from web servers to provide a mediating system where functions of a manager, a secretary and a production company can be carried out at low cost, and fans can attempt to make contact with an athlete, etc., in a carefree manner therefore promoting the communication between the athlete, etc., and his fans and providing business opportunities for the athlete.

However, none of these approaches utilize the fan following on the social networking websites (and corresponding mobile applications) of the celebrity. Further, these approaches fail to monetize the content (pictures/ pictures/videos/any other content related to the personal and/or professional life) posted by the celebrity.

In light of the above stated discussion, there is a need for a method and system which will overcome the above stated drawbacks. Further, the method and system should provide a feeling of having a personalized interaction with the celebrity.

### SUMMARY OF THE INVENTION

The above-mentioned shortcomings, disadvantages and problems are addressed herein which will be understood by reading and understanding the following specification. In an aspect of the present invention, a method for monetizing content of a first user of a social networking platform is provided. The method includes receiving a request from a second user to be associated in a social networking connections of the first user, accepting the second user in the social networking connections of the first user based on the enrollment in at least one of the subscription model, and providing access to a subset of content of the first user to the second user. The second user sends the request by enrolling for at least one of a subscription model. The access to the subset of content is based on a set of privileges defined in enrollment of at least one of the subscription model. The content is posted by the first user.

In an embodiment of the present invention, accepting the second user in the social networking connections of the first user is performed by a third party. The third party is authorized by the first user. In another embodiment of the present invention, accepting the second user in the social networking connections of the first user is performed by a web-based application. In an embodiment, the user of the social networking account authorizes the web-based application. In another embodiment, the web-based application is authorized by a social networking platform. The web-based application enables the second user to access the subset of content based on a set of privileges defined in enrollment of at least one of the subscription model.

In an embodiment of the present invention, the method further includes receiving a request for content in a user profile of the first user at the social networking platform, evaluating a privacy setting associated with the user profile of the first user, comparing the request for content included in the user profile to the privacy setting associated with the user profile, and transmitting a subset of the content included in the user profile to the second user through the social networking platform. In an embodiment of the present invention, providing access to a subset of content of the first user to the second user further includes sending an e-mail having an updated subset of content to the second user after a pre-determined time period defined in at least one of the subscription model.

In an embodiment of the present invention, the first user maintains a record of at least one of the subscription model bought by the second user and a record of at least one of the subscription model bought by one or more users in the social networking connections of the first user. In an embodiment of the present invention, the method further comprises disassociating the second user from the social networking connections of the first user after the expiry of at least one of the subscription models.

In an embodiment of the present invention, disassociating the second user from the social networking connections of the first user is performed by a third party authorized by the first user. In an embodiment of the present invention, disassociating the second user from the social networking connections of the first user is performed by a web-based application. In an embodiment, the user of the social networking account authorizes the web-based application. In another embodiment, the web-based application is authorized by a social networking platform.

In another aspect of the present invention, a method for monetizing content of a first user of a social networking platform is provided. The method includes receiving a request from a second user to be associated in a social networking connections of the first user, accepting the second user in the social networking connections of the first user based on the enrollment in at least one of the subscription model by a third party, delivering a subset of content of the first user to the second user for a pre-defined period of time through a pre-defined communication channel, and disassociating the second user from the social networking connections of the first user after the expiry of at least one of the subscription models. The second user sends the request by enrolling for at least one of a subscription model. The third party is authorized by the first user and the content is posted by the first user. The delivering of the subset of content is based on a set of privileges defined in enrollment of at least one of the subscription model.

In an embodiment of the present invention, the method further includes receiving a request for content in a user profile of the first user, evaluating a privacy setting associated with the user profile of the first user, comparing the request for content included in the user profile to the privacy setting associated with the user profile, and transmitting a subset of the content included in the user profile to the second user through the social networking platform.

In an embodiment of the present invention, delivering of the subset of content of the first user to the second user further includes sending an e-mail having an updated subset of content to the second user after a pre-determined time period defined in at least one of the subscription model. In an embodiment of the present invention, e-mail is sent at a registered e-mail address of the second user provided by the second user enrolling for at least one of the subscription model.

In an embodiment of the present invention, disassociating the second user from the social networking connections of the first user after the expiry of at least one of the subscription models is performed by a web-based application authorized by the social networking platform. In an embodiment of the present invention, accepting the second user in the social networking connections of the first user is performed by a web-based application of the third party.

In another aspect of the present invention, a computer system for monetizing content of a first user of a social networking platform is provided. The computer system includes one or more processors and a non-transitory memory containing instructions. The instructions when executed by the one or more processors cause the one or more processors to perform a set of steps. The set of steps includes receiving a request from a second user in social networking connections of the first user by the social networking platform accessible on the computer system. The second user sends the request by enrolling for at least one of a subscription model.

Further, the method includes accepting the second user in the social networking connections of the first user based on the enrollment in at least one of the subscription model by a third party on the social networking system accessible on the computer system. The third party is authorized by the first user. Furthermore, the method includes delivering a subset of content of the first user to the second user for a pre-defined period of time through a pre-defined communication channel by the social networking platform accessible on the computer system. The delivery of the subset of content is based on a set of privileges defined in enrollment of at least one of the subscription model. The content is posted by the first user.

In an embodiment of the present invention, the method further includes disassociating the second user from the social networking connections of the first user after the expiry of at least one of the subscription models. In an embodiment of the present invention, the non-transitory memory containing instructions when executed by the one or more processors causes the one or more processors to perform a set of steps. The set of steps include receiving a request for content in a user profile of the first user, evaluating a privacy setting associated with the user profile of the first user, comparing the request for content included in the user profile to the privacy setting associated with the user profile and transmitting a subset of the content included in the user profile to the second user through the social networking platform.

In an embodiment of the present invention, the non-transitory memory containing instructions when executed by the one or more processors causes the one or more processors to perform delivering of the subset of content of the first user to the second user by sending an e-mail having an updated subset of content to the second user after a pre-determined time period defined in at least one of the subscription model. The e-mail is sent at a registered e-mail address of the second user provided by the second user enrolling for at least one of the subscription model.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

For a more complete understanding of example embodiments of the present technology, reference is now made to the following descriptions taken in connection with the accompanying drawings in which:

FIG. 1 illustrates a system for monetizing content for users of a social networking platform, in accordance with various embodiments of the present invention;

FIG. 2 illustrates a flowchart for monetizing content for users of a social networking platform, in accordance with various embodiments of the present invention;

FIG. 3 illustrates a flowchart for listing and delisting of users to access the content of a celebrity, in accordance with various embodiments of the present invention; and

FIG. 4 illustrates a computer system for monetizing content for users of a social networking platform, in accordance with various embodiments of the present invention.

### DETAILED DESCRIPTION OF THE INVENTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

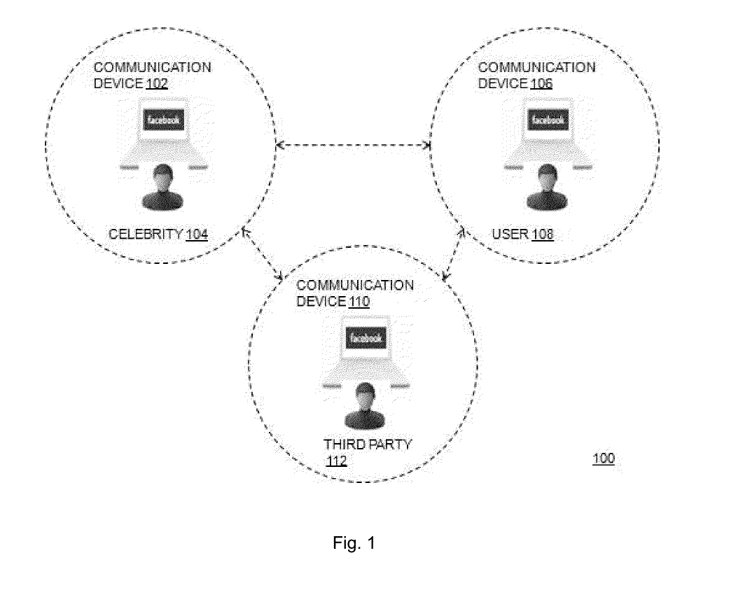

FIG. 1 illustrates a system 100 for monetizing content for users of a social networking platform, in accordance with various embodiments of the present invention. The system 100 includes a communication device 102, a communication device 106 and a communication device 110. The communication device 102 is associated with a celebrity 104. In addition, the communication device 106 is associated with a user 108 and the communication device 110 is associated with a third party 112. Examples of the communication device 102, the communication device 106 and the communication device 110 include but may not be limited to a laptop, a personal digital assistant (PDA), a Smartphone, and a desktop computer. The communication device 102, the communication device 106 and the communication device 110 have the ability to access different social networking platforms. Examples of the social networking platforms include but may not be limited to Facebook, Google+, FourSquare, LinkedIn, and Twitter.

The celebrity 104 can be a music artist, a sportsperson, a politician, a dancer, a media personality, an actor, a corporate executive, an athlete, a group including one or more of all these people, a music band, a team, and the like. The celebrity 104 may have accounts on different social networking platforms. By using these accounts, the celebrity 104 utilizes the functionality provided by the social networking platform. For example, the celebrity 104 can search for his/her friends, post his/her pictures, videos, and the like on the social networking platform.

The user 108 may be a fan or a follower of the celebrity 104. The user 108 may like to view the content posted by the celebrity 104. However, since the user 108 does not have any acquaintance with the celebrity 104, the celebrity 104 may not add the user 108 in his/her social network connection in the social networking platform. In addition, the celebrity 104 may receive thousands or millions of requests from multiple users (fans and followers). The celebrity 104 may not opt to add any of his fan/follower in his social networking connections. The celebrity 104 may add only his/her acquaintance. In this scenario, the fan/followers of the social networking platform may only view a limited content posted by the celebrity 104. The amount and type of content which a follower may be able to view/download depends on the privacy settings provided by the social networking platform and the privacy settings utilized by the celebrity 104. Example of the content include but not limited to images, videos, likes, dislikes, events, and any other content related to the personal and/or professional life.

In an embodiment of the present invention, a particular social networking platform may give the user 108 (who is just a follower of the celebrity 104 but not a social connect of the celebrity 104) an option to view/download a subset of the content posted by the celebrity 104. For example, the social networking platform may give the user 108 an option to view all the images posted by the celebrity 104 three months ago. The user 108 may not be able to view the current images/videos posted by the celebrity 104. In another embodiment, a social networking platform may not allow the user 108 (who is just a follower of the celebrity 104 but not added in the social connections) to view any content posted by the celebrity 104.

In an embodiment of the present, the celebrity 104 authorizes the third party 112 to manage his/her social networking account. The third party 112 can be a person, a media agency, a PR agency, a bunch of digital marketing professionals, and the like. In an embodiment of the present invention, the celebrity 104 may share the credentials associated with the social networking platform with the third party 112. Examples of the credentials include but may not be limited to a login id and a password chosen by the celebrity 104 to access the social networking platform. In an embodiment of the present invention, once the celebrity 104 authorizes the third party 112, the social networking platform gives the third party 112 access to all the functionalities associated with the account of the celebrity 104. In another embodiment, once the celebrity 104 authorizes the third party 112, the social networking platform gives the third party 112 partial accesses to the functionality of the account of the celebrity 104. For example, the celebrity 104 may allow the third party 112 to access/add/modify his/her social connects. However, the celebrity 104 may have the liberty to post the content on his own.

Once the celebrity 104 authorizes the third party 112, the third party 112 can manually add all the followers/fans. For example, the third party 112 may provide the user 108 an option through the social networking platform to enroll for a plan through which the user 108 can view/download the content posted by the celebrity 104. In an embodiment of the present invention, there can be multiple plans which the user 108 can utilize. Each plan may have a time period in which the user 108 can view/download the content posted by the celebrity 104. In an embodiment of the present invention, the third party 112 may maintain a database of the fans that have enrolled for the paid subscription. Based on the type of the plan, the third party 112 can list or de-list the user 108 (or multiple users) for viewing the content. In an embodiment of the present invention, once the user 108 enrolls for a subscription plan, the third party 112 manually adds/accepts the user 108 in the list of the social connections of the celebrity 104. Once the subscription ends, the third party 112 manually de-lists the user 108 from the list of the social connections of the celebrity 104. In this manner, the user 108 can view/download the content posted by the celebrity 104.

In an embodiment of the present invention, a web-based application and/or the celebrity 104 authorized by the social networking platform enables listing and/or de-listing the user 108 (or many other fan and/or followers) in the social connections of the celebrity 104. The user 108 accesses the content posted by the celebrity 104 based on a set of privileges defined in enrollment of the subscription model. In another embodiment of the present invention, the third party 112 may access the web-based application authorized by the social networking platform and/or the celebrity 104 to allow access of the content to the user 108 (and/or multiple users). In another embodiment of the present invention, the celebrity 104 may access the web-based application authorized by the social networking platform and/or the celebrity 104 to allow access of the content to the user 108 (and/or multiple users).

In an embodiment of the present invention, the content may be sent to the user 108 (after enrolling with a subscription model) on a registered e-mail address. In an embodiment of the present invention, the content may be transmitted to the user 108 after regular period of time, say after every 12 hours. In an embodiment of the present invention, only an updated content may be transmitted to the user 108 after regular period of time. The content may not be transmitted to the user 108 once the subscription period of the enrolment expires. In an embodiment of the present invention, the web-based application authorized by the social networking platform and/or the celebrity 104 automatically enables de-listing of the content associated with the user 108 after the expiry of the subscription.

In an embodiment of the present invention, the user 108 may be provided with different categories of content based on the subscription model. For example, the social networking platform may enable the celebrity 104 to categorize the content into different sets. The different sets can be free, exclusive, premium, and the like. The access to each category of the content is associated with the category of the content. For example, the premium content may cost the user 108 50 USD/month; the exclusive content may cost the user 108 USD 100/month; and the like.

It may be noted that the FIG. 1 is shown to have only the one user 108 who is a fan/follower of the celebrity 104; however, those skilled in the art would appreciated that there will be multiple followers of the celebrity 104 who may be listed or de-listed based on the different subscription models. In addition, there can be different celebrities who have multiple fans and/or followers. In addition, the above stated embodiments can be used in different scenarios. For example, the third party 112 may create a page for the live concert of the celebrity 104. The fans who may want to attend the concert may need to pay the amount by enrolling/paying through the subscription and accordingly, get added in the social connections for the concert/celebrity 104. In an embodiment of the present invention, the third party 112 is authorized to manage the list of the users who are added in the social connections to attend the concert by paying for the concert.

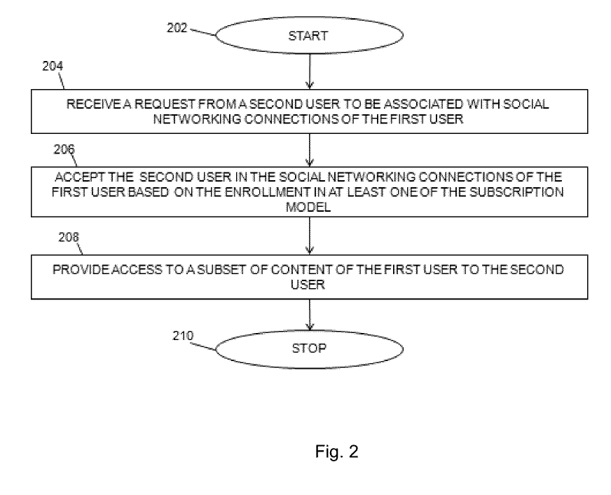

FIG. 2 illustrates a flowchart 200 for monetizing content for users of a social networking platform, in an aspect of the present invention. It may be noted that the flow chart 200 can have more or less number of steps which will enable the implementation of the invention within the scope. In addition, it may be noted that to explain the flow chart 200, references will be made to the system elements explained in FIG. 1.

The flowchart 200 initiates at step 202. At step 204, a second user (referred to as user 108 in the FIG. 1) sends a request to be associated in social networking connections of the first user (referred to as the celebrity 104 in the FIG. 1). As explained in the description for FIG. 1, the second user (the user 108) sends the request by enrolling for at least one of a subscription model. At step 206, the request of the second user (the user 108) is accepted based on the enrollment in at least one of the subscription model. In an embodiment of the present invention, accepting the second user (the user 108) in the social networking connections of the first user (the celebrity 104) is performed by the third party 112. The third party 112 is authorized by the first user (the celebrity 104). In another embodiment of the present invention, the second user (the user 108) is accepted in the social networking connections of the first user (the celebrity 104) is performed by a web-based application authorized by the social networking platform and/or the celebrity 104. At step 208, as explained in the description for FIG. 1, the access to a subset of content of the first user (the celebrity 104) to the second user (the user 108) is provided. The access to the subset of content is based on a set of privileges defined in enrollment of at least one of the subscription model. The content is posted by the first user (the celebrity 104). In an embodiment of the present invention, the web-based application enables the second user to access the subset of content based on a set of privileges defined in enrollment of at least one of said subscription model. The flowchart 210 terminates at step 210.

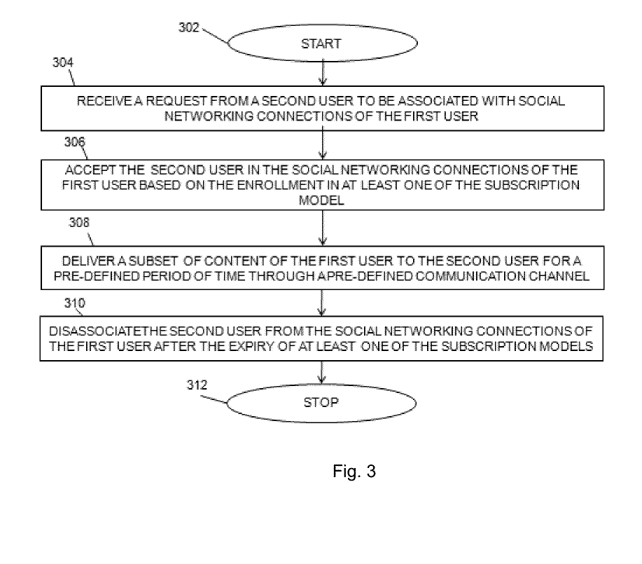

FIG. 3 illustrates a flowchart 300 for monetizing content for users of a social networking platform, in another aspect of the present invention. It may be noted that the flow chart 300 can have more or less number of steps which will enable the implementation of the invention within the scope. In addition, it may be noted that to explain the flow chart 300, references will be made to the system elements explained in FIG. 1.

The flowchart 300 initiates at step 302. At step 304, a request from the second user (the user 108) to be associated in the social networking connections of the first user (the celebrity 104) is received. As explained above for the description of FIG. 1, the second user (the user 108) sends the request by enrolling for at least one of a subscription model. At step 306, the second user (the user 108) is accepted in the social networking connections of the first user (the celebrity 104) based on the enrollment in at least one of said subscription model by the third party 112. The third party 112 is authorized by the first user (the celebrity 104). At step 308, a subset of content of the first user (the celebrity 104) is delivered to the second user for a pre-defined period of time through a pre-defined communication channel. The delivering of the subset of content is based on a set of privileges defined in enrollment of at least one of the subscription model and the content is posted by the first user (the celebrity 104). At step 310, the second user (the user 108) is disassociated from said social networking connections of the first user (the celebrity 104) after the expiry of at least one of the subscription models. The flowchart 300 terminates at step 312.

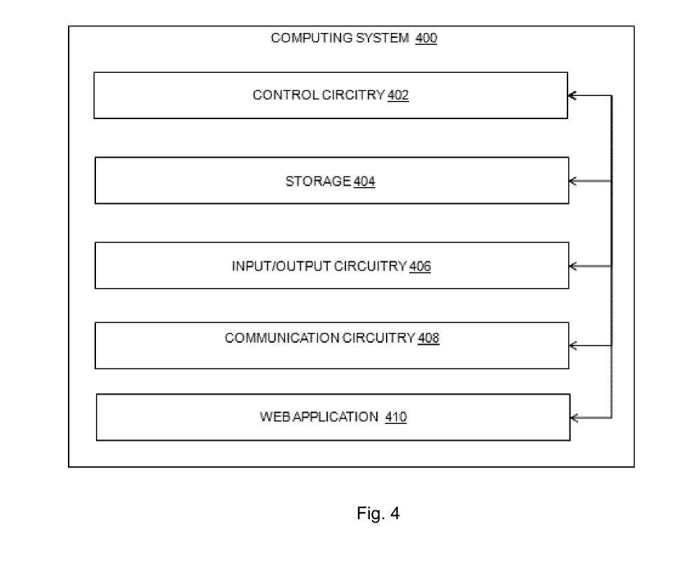

In an embodiment of the present invention, the social networking platform is accessed by the celebrity 104, the user 108 and the third party 112 from the communication device 102, the communication device 106 and the communication device 112 respectively. The communication device 102, the communication device 106 and the communication device 112 (referred to as a communication device 400 in FIG. 4) have some common characteristics which enable the implementation of above explained embodiments. As illustrated in the FIG. 4, the communication device 400 includes a control circuitry 402, storage 404, an input/output (“I/O”) circuitry 406, a communications circuitry 408 and the web application module 410. The control circuitry 402, storage 404, the input/output (“I/O”) circuitry 406, the communications circuitry 408 in conjunction with the web application module 410 enables monetizing content for users of a social networking platform.

Those skilled in the art would appreciate that the communication device 400 of FIG. 4 may include one or more components which may not be shown here. These one or more components of the communication device 400 may be combined or omitted with the components shown in FIG. 4. The communication device 400 includes any suitable type of electronic device. Examples of the communication device 400 include but may not be limited to a digital media player (e.g., an iPod™. made available by Apple Inc. of Cupertino, Calif.), a personal e-mail device (e.g., a Blackberry™. made available by Research in Motion of Waterloo, Ontario), a personal data assistant (“PDA”), a cellular telephone, a Smartphone, a handheld gaming device, a digital camera, a laptop computer, and a tablet computer. In another embodiment of the present invention, the communication device 400 can be a desktop computer.

From the perspective of this invention, the control circuitry 402 includes any processing circuitry or processor operative to control the operations and performance of the communication device 400. For example, the control circuitry 402 may be used to run operating system applications, firmware applications, media playback applications, media editing applications, or any other application. In an embodiment of the present invention, the control circuitry 402 drives a display and process inputs received from a user interface.

From the perspective of this invention, the storage 404 includes one or more storage mediums including a hard-drive, solid state drive, flash memory, permanent memory such as ROM, any other suitable type of storage component, or any combination thereof. The Storage 404 may store, for example, media data (e.g., music and video files), application data (e.g., for implementing functions on the communication device 400).

From the perspective of this invention, the I/O circuitry 406 may be operative to convert (and encode/decode, if necessary) analog signals and other signals into digital data. In an embodiment of the present invention, the I/O circuitry 406 may also convert digital data into any other type of signal, and vice-versa. For example, the I/O circuitry 406 may receive and convert physical contact inputs (e.g., from a multi-touch screen), physical movements (e.g., from a mouse or sensor), analog audio signals (e.g., from a microphone), or any other input. The digital data may be provided to and received from the control circuitry 402, the storage 404, or any other component of the communication device 400.

It may be noted that the I/O circuitry 406 is illustrated in FIG. 4 as a single component of the communication device 400; however those skilled in the art would appreciate that several instances of the I/O circuitry 406 may be included in the communication device 400.

The communication device 400 may include any suitable interface or component for allowing a user to provide inputs to the I/O circuitry 406. The communication device 400 may include any suitable input mechanism. Examples of the input mechanism include but may not be limited to a button, keypad, dial, a click wheel, and a touch screen. In an embodiment of the present invention, the communication device 400 may include a capacitive sensing mechanism, or a multi-touch capacitive sensing mechanism.

In an embodiment of the present invention, the communication device 400 may include specialized output circuitry associated with output devices such as, for example, one or more audio outputs. The audio output may include one or more speakers built into the communication device 400, or an audio component that may be remotely coupled to the communication device 400.

The one or more speakers can be mono speakers, stereo speakers, or a combination of both. The audio component can be a headset, headphones or ear buds that may be coupled to communications device with a wire or wirelessly.

In an embodiment of the present invention, the I/O circuitry 406 may include display circuitry for providing a display visible to the user. For example, the display circuitry may include a screen (e.g., an LCD screen) that is incorporated in the communication device 400.

The display circuitry may include a movable display or a projecting system for providing a display of content on a surface remote from the communication device 400 (e.g., a video projector). In an embodiment of the present invention, the display circuitry may include a coder/decoder to convert digital media data into analog signals. For example, the display circuitry may include video Codecs, audio Codecs, or any other suitable type of Codec.

The display circuitry may include display driver circuitry, circuitry for driving display drivers, or both. The display circuitry may be operative to display content. The display content can include media playback information, application screens for applications implemented on the electronic device, information regarding ongoing communications operations, information regarding incoming communications requests, or device operation screens under the direction of the control circuitry 402. Alternatively, the display circuitry may be operative to provide instructions to a remote display.

From the prospective of this invention, a communications circuitry 408 may include any suitable communications circuitry operative to connect to a communications network and to transmit communications (e.g., voice or data) from the communication device 400 to other devices within the communications network. The communications circuitry 408 may be operative to interface with the communications network using any suitable communications protocol. Examples of the communications protocol include but may not be limited to Wi-Fi, Bluetooth®, radio frequency systems, infrared, LTE, GSM, GSM plus EDGE, CDMA, and quadband.

In an embodiment of the present invention, the same instance of the communications circuitry 408 may be operative to provide for communications over several communications networks. In an embodiment of the present invention, the communication device 400 may be coupled a host device for data transfers, synching the communications device, software or firmware updates, providing performance information to a remote source (e.g., providing riding characteristics to a remote server) or performing any other suitable operation that may require the communication device 400 to be coupled to a host device. Several computing devices may be coupled to a single host device using the host device as a server. Alternatively or additionally, the communication device 400 may be coupled to several host devices (e.g., for each of the plurality of the host devices to serve as a backup for data stored in the communication device 400).

The disclosed present invention overcomes the problems and disadvantages of the prior art. The well known talent or celebrities commands the attention of anywhere between thousands and millions of fans via the social media channels. The present invention will enables these celebrities to generate exclusive and paid content that will be distributed through a controlled and verified list of the fan. The third party will manage the list of the fans based on the money these fans will pay for the content.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for monetizing content of a first user of a social networking platform, said method comprising:
receiving a request from a second user to be associated with social networking connections of said first user, wherein said second user sends the request by enrolling for at least one of a subscription model;
accepting said second user in said social networking connections of said first user based on the enrollment in at least one of said subscription model; and
providing access to a subset of content of said first user to said second user, wherein said access to said subset of content is based on a set of privileges defined in enrollment of at least one of said subscription model, and wherein said content is posted by said first user.

2. The method as recited in claim 1, wherein accepting said second user in said social networking connections of said first user is performed by a third party, wherein said third party is authorized by said first user.

3. The method as recited in claim 1, wherein accepting said second user in said social networking connections of said first user is performed by a web-based application authorized by at least one of said social networking platform and said first user, wherein said web-based application enables said second user to access said subset of content based on a set of privileges defined in enrollment of at least one of said subscription model.

4. The method as recited in claim 1, further comprising:
receiving, at said social networking platform, a request for content in a user profile of said first user;
evaluating a privacy setting associated with said user profile of said first user;
comparing said request for content included in said user profile to said privacy setting associated with said user profile; and
transmitting a subset of the content included in said user profile to said second user through the social networking platform.

5. The method as recited in claim 1, wherein providing access to a subset of content of said first user to said second user further comprises sending an e-mail having an updated subset of content to said second user after a pre-determined time period defined in at least one of said subscription model.

6. The method as recited in claim 1, wherein said first user maintains a record of at least one of said subscription model bought by said second user and a record of at least one of said subscription model bought by one or more users in said social networking connections of said first user.

7. The method as recited in claim 1, further comprising disassociating said second user from said social networking connections of said first user after said expiry of at least one of said subscription models.

8. The method as recited in claim 7, wherein disassociating said second user from said social networking connections of said first user is performed by a third party authorized by said first user.

9. The method as recited in claim 1, wherein disassociating said second user from said social networking connections of said first user is performed by a web-based application authorized by at least one of said social networking platform and said first user.

10. A method for monetizing content of a first user of a social networking platform, said method comprising:
receiving a request from a second user to be associated in social networking connections of said first user, wherein said second user sends the request by enrolling for at least one of a subscription model;
accepting said second user in said social networking connections of said first user based on the enrollment in at least one of said subscription model by a third party, wherein said third party is authorized by said first user;
delivering a subset of content of said first user to said second user for a pre-defined period of time through a pre-defined communication channel, wherein said delivering of said subset of content is based on a set of privileges defined in enrollment of at least one of said subscription model, and wherein said content is posted by said first user; and
disassociating said second user from said social networking connections of said first user after said expiry of at least one of said subscription models.

11. The method as recited in claim 10, further comprising:
receiving, at said social networking platform, a request for content in a user profile of said first user;
evaluating a privacy setting associated with said user profile of said first user;
comparing said request for content included in said user profile to said privacy setting associated with said user profile; and
transmitting a subset of the content included in said user profile to said second user through the social networking platform.

12. The method as recited in claim 10, wherein said delivering of said subset of content of said first user to said second user further comprises sending an e-mail having an updated subset of content to said second user after a pre-determined time period defined in at least one of said subscription model.

13. The method as recited in claim 12, wherein said e-mail is sent at a registered e-mail address of said second user provided by said second user enrolling for at least one of said subscription model.

14. The method as recited in claim 10, wherein disassociating said second user from said social networking connections of said first user after said expiry of at least one of said subscription models is performed by a web-based application authorized by at least one of said social networking platform and said first user.

15. The method as recited in claim 10, accepting said second user in said social networking connections of said first user is performed by a web-based application of said third party, wherein said web-based application is authorized by at least one of said social networking platform and said first user.

16. A computer system for monetizing content of a first user of a social networking platform, said system comprising:
one or more processors; and
a non-transitory memory containing instructions that, when executed by said one or more processors, causes said one or more processors to perform a set of steps comprising:
receiving, by said social networking platform accessible on said computer system, a request from a second user in a social networking connections of said first user, wherein said second user sends the request by enrolling for at least one of a subscription model;
accepting, by a third party on said social networking system accessible on said computer system, said second user in said social networking connections of said first user based on the enrollment in at least one of said subscription model by a third party, wherein said third party is authorized by said first user; and
delivering, by said social networking platform accessible on said computer system, a subset of content of said first user to said second user for a pre-defined period of time through a pre-defined communication channel, wherein said delivering of said subset of content is based on a set of privileges defined in enrollment of at least one of said subscription model, and wherein said content is posted by said first user.

17. The system as recited in claim 16, further comprising disassociating, by said networking platform accessible on said computing system, said second user from said social networking connections of said first user after said expiry of at least one of said subscription models.

18. The system as recited in claim 16, wherein said non-transitory memory containing instructions that, when executed by said one or more processors, causes said one or more processors to perform further a set of steps comprising:
receiving, at said social networking platform, a request for content in a user profile of said first user;
evaluating a privacy setting associated with said user profile of said first user;
comparing said request for content included in said user profile to said privacy setting associated with said user profile; and
transmitting a subset of the content included in said user profile to said second user through the social networking platform.

19. The system as recited in claim 16, wherein said non-transitory memory containing instructions that, when executed by said one or more processors, causes said one or more processors to perform delivering of said subset of content of said first user to said second user further comprises sending an e-mail having an updated subset of content to said second user after a pre-determined time period defined in at least one of said subscription model.

20. The system as recited in claim 16, wherein e-mail is sent at a registered e-mail address of said second user provided by said second user enrolling for at least one of said subscription model.
